(19) United States
(12) Patent Application Publication
(10) Pub. No.: US 2026/0143393 A1
(43) Pub. Date: May 21, 2026

(54) MOBILITY PROCEDURE USING LOW POWER RECEIVER

(71) Applicant: QUALCOMM Incorporated, San Diego, CA (US)

(72) Inventors: Jung Ho RYU, Englewood Cliffs, NJ (US); Jelena DAMNJANOVIC, Del Mar, CA (US); Igor GUTMAN, Hod HaSharon (IL); Tao LUO, San Diego, CA (US)

(21) Appl. No.: 18/949,082

(22) Filed: Nov. 15, 2024

(51) Int. Cl. H04W 36/08; H04W 36/00

(52) U.S. Cl. CPC H04W 36/08; H04W 36/0058

(57) ABSTRACT

Various aspects of the present disclosure generally relate to wireless communication. In some aspects, a user equipment (UE) may perform, using a low power receiver at the UE, one or more measurements associated with a lower layer triggered mobility (LTM) procedure. The UE may transmit a measurement report comprising a first indication of the one or more measurements and a second indication that the one or more measurements are performed using the low power receiver. The UE may receive, based at least in part on transmitting the measurement report, a command associated with the LTM procedure, the command indicating for the UE to switch from a first serving cell to a second serving cell. Numerous other aspects are described.

### FIELD OF THE DISCLOSURE

Aspects of the present disclosure generally relate to wireless communication and specifically relate to techniques, apparatuses, and methods associated with a mobility procedure using a low power receiver.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include performing, using a low power receiver at the UE, one or more measurements associated with a lower layer triggered mobility (LTM) procedure. The method may include transmitting a measurement report comprising a first indication of the one or more measurements and a second indication that the one or more measurements are performed using the low power receiver. The method may include receiving, based at least in part on transmitting the measurement report, a command associated with the LTM procedure, the command indicating for the UE to switch from a first serving cell to a second serving cell.

Some aspects described herein relate to an apparatus for wireless communication at a UE. The apparatus may include one or more memories and one or more processors coupled to the one or more memories. The one or more processors may be configured to perform, using a low power receiver at the UE, one or more measurements associated with an LTM procedure. The one or more processors may be configured to transmit a measurement report comprising a first indication of the one or more measurements and a second indication that the one or more measurements are performed using the low power receiver. The one or more processors may be configured to receive, based at least in part on transmitting the measurement report, a command associated with the LTM procedure, the command indicating for the UE to switch from a first serving cell to a second serving cell.

Some aspects described herein relate to a non-transitory computer-readable medium that stores a set of instructions for wireless communication by a UE. The set of instructions, when executed by one or more processors of the UE, may cause the UE to perform, using a low power receiver at the UE, one or more measurements associated with an LTM procedure. The set of instructions, when executed by one or more processors of the UE, may cause the UE to transmit a measurement report comprising a first indication of the one or more measurements and a second indication that the one or more measurements are performed using the low power receiver. The set of instructions, when executed by one or more processors of the UE, may cause the UE to receive, based at least in part on transmitting the measurement report, a command associated with the LTM procedure, the command indicating for the UE to switch from a first serving cell to a second serving cell.

Some aspects described herein relate to an apparatus for wireless communication. The apparatus may include means for performing, using a low power receiver at the apparatus, one or more measurements associated with an LTM procedure. The apparatus may include means for transmitting a measurement report comprising a first indication of the one or more measurements and a second indication that the one or more measurements are performed using the low power receiver. The apparatus may include means for receiving, based at least in part on transmitting the measurement report, a command associated with the LTM procedure, the command indicating for the apparatus to switch from a first serving cell to a second serving cell.

Aspects of the present disclosure may generally be implemented by or as a method, apparatus, system, computer program product, non-transitory computer-readable medium, UE, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a wireless communication network, in accordance with the present disclosure.

FIG. 4 is a diagram illustrating an example of a lower layer triggered mobility (LTM) procedure, in accordance with the present disclosure.

FIG. 5 is a diagram illustrating an example of timing advance acquisition, in accordance with the present disclosure.

FIG. 6 is a diagram illustrating an example of a measurement report transmission, in accordance with the present disclosure.

FIG. 7 is a diagram illustrating an example process performed, for example, at a UE or an apparatus of a UE, in accordance with the present disclosure.

FIG. 8 is a diagram illustrating an example process performed, for example, at a network node or an apparatus of a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some wireless communication, a network node may configure a user equipment (UE) to perform a mobility procedure to switch from a first serving cell to a second serving cell. In one example, the network node may configure the UE to perform a lower layer triggered mobility (LTM) procedure for the mobility procedure. For an LTM procedure, the network node (e.g., that is associated with and/or provides the first serving cell) may prepare one or more candidate serving cells and indicate the candidate cell configurations to the UE by radio resource control (RRC) signaling. Then, the network node may indicate for the UE to switch from the first serving cell to a second serving cell (e.g., one of the candidate serving cells) based on one or more measurement reports transmitted from the UE to the network node. In particular, the UE may perform measurements of one or more of the candidate serving cells and may provide, to the network node, an indication of the measurements via a measurement report.

To perform the measurements of a candidate serving cell, the UE may monitor resources to perform measurements of one or more signals (e.g., a synchronization signal block (SSB), a reference signal) transmitted by the candidate serving cell. For example, the UE may refrain from communicating with the network node (e.g., that is providing the first serving cell) using a main radio of the UE in order to perform one or more measurements on the signals transmitted by the candidate serving cell. Then, the UE may begin communicating with the first serving cell (e.g., may use the main radio to receive and/or transmit signaling to the network node via the first serving cell) and may transmit, to the network node, a measurement report indicating one or more of the measurements associated with the candidate serving cell. In some cases, however, refraining from communicating with the first serving cell in order to perform measurements of a candidate serving cell (e.g., to generate the measurement report used for the LTM procedure) may introduce latency into communications performed with the first serving cell. That is, the network node and the UE may delay communications until after the UE has completed the measurements of the candidate serving cell.

In wireless communication networks described herein, the UE may rely on a low power receiver at the UE to perform the measurements of the candidate serving cell and to generate the measurement report for the LTM procedure. In particular, the UE may include both the main radio and the low power receiver and may be capable of performing communications using both the main radio and the low power receiver during overlapping time intervals. Accordingly, the UE may perform one or more measurements of a candidate serving cell using the low power receiver at the UE while also communicating with the first serving cell using the main radio at the UE. Then the UE may transmit, and the network node (e.g., that provides the first serving cell) may receive, the measurement report that includes at least one measurement performed using the low power receiver at the UE. The measurement report may also include an indication that the measurement was performed using the low power receiver. Then, based on the measurement report received from the UE, the network node may identify a second serving cell for the LTM procedure and transmit, to the UE, a command for the UE to switch from the first serving cell to the second serving cell.

Particular aspects of the subject matter described in this disclosure can be implemented to realize one or more of the following potential advantages. In some examples, the described techniques can be used to decrease latencies associated with communications between a UE and a serving cell while the UE performs measurements associated with an LTM procedure. Additionally, indicating which measurements are performed using a low power procedure may improve a coordination between the UE and network node.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

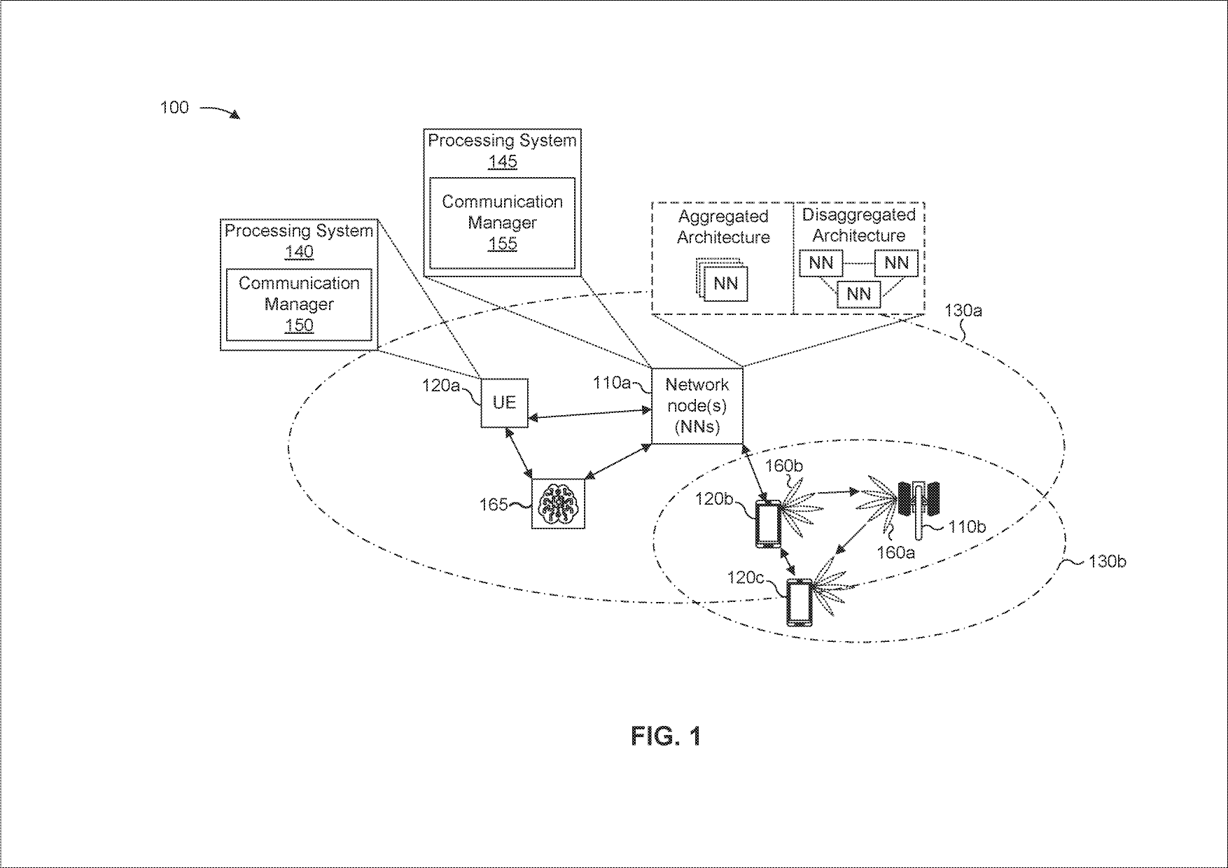

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

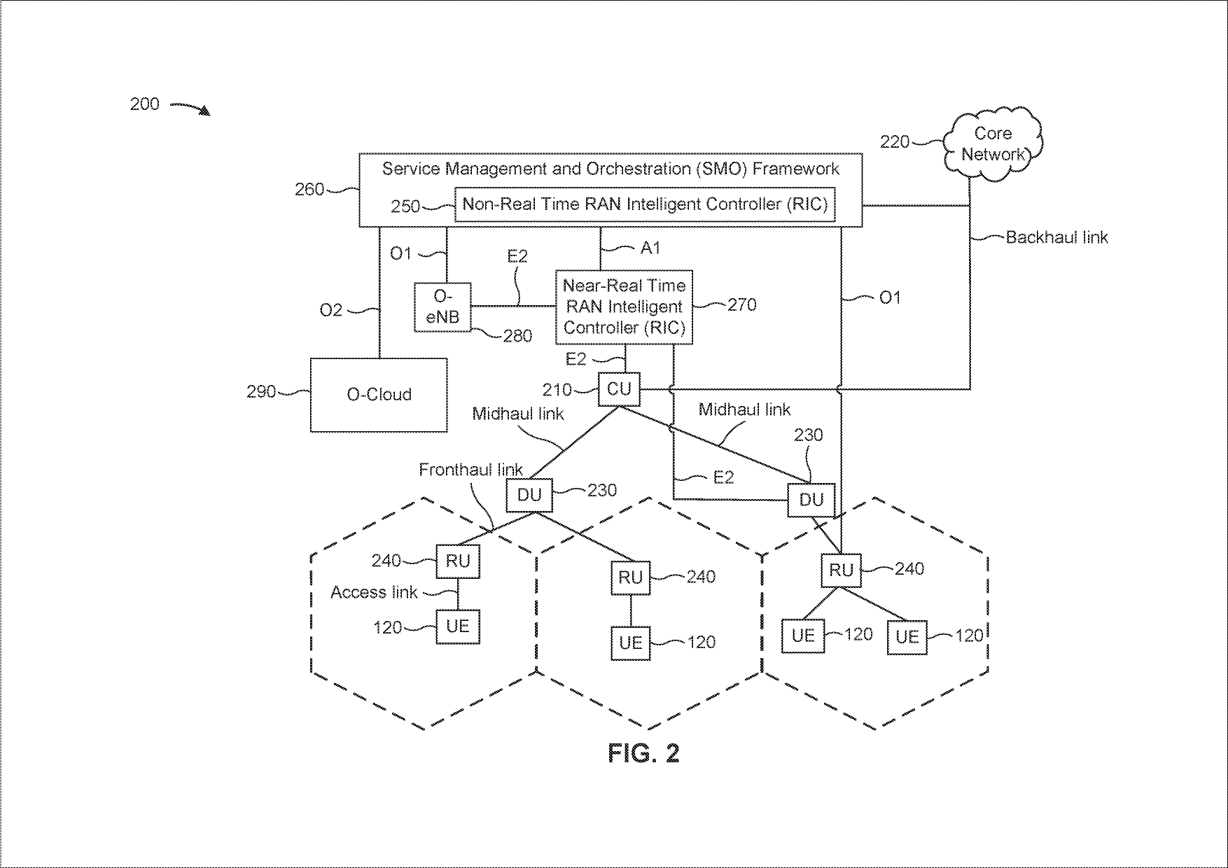

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SSB (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In the wireless communication network 100, a first wireless communication device (e.g., a UE 120) may perform a mobility procedure to switch from a first serving cell to a second serving cell. In one example, the first wireless communication device may perform a handover procedure to switch to the second serving cell. The handover procedure may be based on network-controlled UE 120 mobility, where the network (e.g., a network node 110) transmits semi-static Layer 3 (L3) RRC signaling indicating the handover command, and the handover is based on an L3 measurement report transmitted from the UE 120 to the network node 110. For a handover, the source network node 110 (e.g., associated with the first serving cell) may initiate the handover by sending a handover command that includes a target cell (e.g., the second serving cell) configuration. The UE 120 may access the cell after the target cell configuration is applied.

In another example, the first wireless communication device may perform a conditional handover procedure to switch to the second serving cell. The conditional handover procedure may also be a an L3-based handover. In particular, the conditional handover may be controlled by L3 signaling, and multiple candidate target cells may be prepared in advance (e.g., prior to the UE 120 determining to perform the conditional handover) when the conditions (e.g., the signal qualities of communications between the UE 120 and the serving cell) are good. The UE 120 may execute the conditional handover in response to determining that one or more conditions that are configured for the conditional handover are met.

In another example, the first wireless communication device may perform a lower layer mobility procedure. That is, one enhancement for multi-beam operation at higher carrier frequencies is facilitation of efficient (for example, low latency and low overhead) downlink and/or uplink beam management operations to support Layer 1 and/or Layer 2 (L1/L2)-centric inter-cell mobility. L1/L2 signaling may be referred to as “lower layer” signaling. L1/L2 signaling may be used to activate and/or deactivate candidate cells in a set of cells configured for LTM and/or to provide reference signals for measurement by the UE 120, by which the UE 120 may select a candidate beam as a target beam for a lower layer handover operation. In particular, for an LTM procedure, the first serving cell (e.g., a network node 110 associated with the first serving cell) may prepare one or more candidate serving cells and indicate the candidate cell configurations to the UE 120 by RRC signaling. Then, the first serving cell may indicate for the UE 120 to switch from the first serving cell to a second serving cell (e.g., one of the candidate serving cells) based on L1 measurements and reporting. Accordingly, L1/L2-centric inter-cell mobility may enable a UE 120 to perform a cell switch via dynamic control signaling at lower layers (for example, DCI for L1 signaling or a MAC-CE for L2 signaling), rather than semi-static L3 RRC signaling. Thus, L1/L2 centric inter-cell mobility may reduce latency, reduce overhead, and/or otherwise increase efficiency of the cell switch.

The UE 120 may perform the LTM procedure to switch from a first serving cell (which may also be referred to as a source) to a second serving cell (which may also referred to as a target cell). In a first example, the switch from the first serving cell to the second serving cell may correspond to an inter-DU switch. That is, the first serving cell and the second serving cells may be associated with different DUs. In one case of the inter-DU switch, a first network node 110 that includes a first DU (e.g., a first gNB-DU) may provide the first serving cell and a second network node 110 that includes a second DU (e.g., a second gNB-DU) may provide the second serving cell. Here, both the first and second network nodes 110 may communicate with a third network node 110 that includes a CU (e.g., a gNB-CU). In another case of the inter-DU switch, a first network node 110 that includes a first RU may provide the first serving cell and a second network node 110 that includes a second RU may provide the second serving cell. Here, the first network node 110 that includes the first RU may communicate with one DU (e.g., a network node 110 that includes a DU, such as a first gNB-DU) and the second network node 110 that includes the second RU may communicate with another DU (e.g., a different network node 110 that includes a different DU, such as a second gNB-DU). Accordingly, when the UE 120 switches from the first serving cell (e.g., provided by the first RU) to the second serving cell (e.g., provided by the second RU), the UE 120 may be performing an inter-DU switch (e.g., from the first gNB-DU to the second gNB-DU). In some cases, both the first and second gNB-DUs may communicate with a same CU (e.g., a third network node 110 that includes a CU, such as a gNB-CU).

In another example, the UE 120 may switch from a first serving cell to a second serving cell as part of an intra-DU and intra-CU switch. That is, while the UE 120 switches from the first serving cell to the second serving cell, both the first and second serving cells may be associated with a same CU and DU. In one case of an intra-DU and intra-CU switch, the first serving cell may be provided by a first network node 110 that includes a first RU and the second serving cell may be provided by a second network node 110 that includes a second RU. Further, the first RU and the second RU may both communicate with a same third network node 110 that includes both a CU and a DU (e.g., a gNB-CU+DU). Additionally, or alternatively, the first RU and the second RU may both communicate with a same third network node 110 that includes a DU (e.g., a gNB-DU), and the third network node 110 may in turn communicate with a fourth network node 110 that includes a CU (e.g., a gNB-CU).

In some aspects, the UE 120 may include a communication manager 150. As described in more detail elsewhere herein, the communication manager 150 may perform, using a low power receiver at the UE, one or more measurements associated with an LTM procedure; transmit a measurement report comprising a first indication of the one or more measurements and a second indication that the one or more measurements are performed using the low power receiver; and receive, based at least in part on transmitting the measurement report, a command associated with the LTM procedure, the command indicating for the UE to switch from a first serving cell to a second serving cell. Additionally, or alternatively, the communication manager 150 may perform one or more other operations described herein.

In some aspects, the network node 110 may include a communication manager 155. As described in more detail elsewhere herein, the communication manager 155 may receive, from a UE, a measurement report comprising a first indication of one or more measurements associated with an LTM procedure and a second indication that the one or more measurements are performed using a low power receiver at the UE; and transmit, based at least in part on the one or more measurements, a command associated with the LTM procedure, the command indicating for the UE to switch from a first serving cell associated with the network node to a second serving cell. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

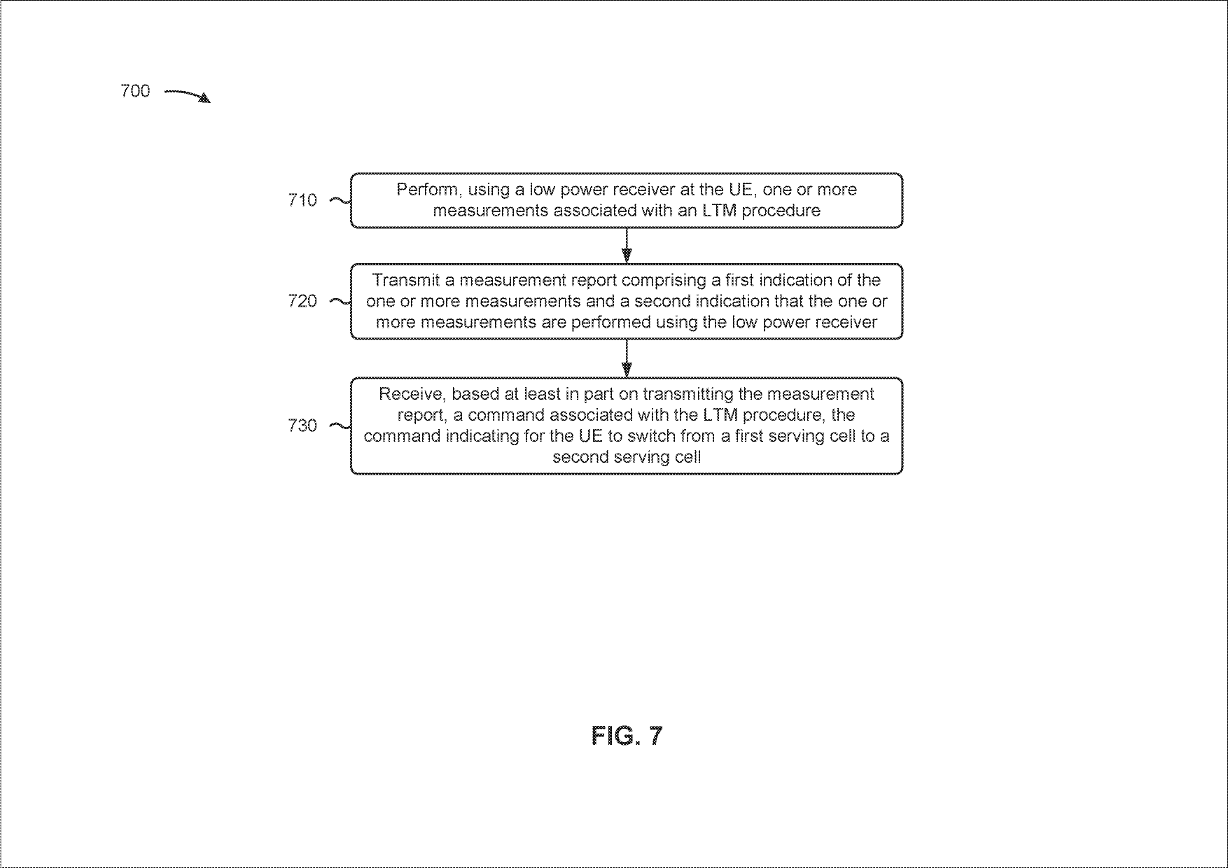

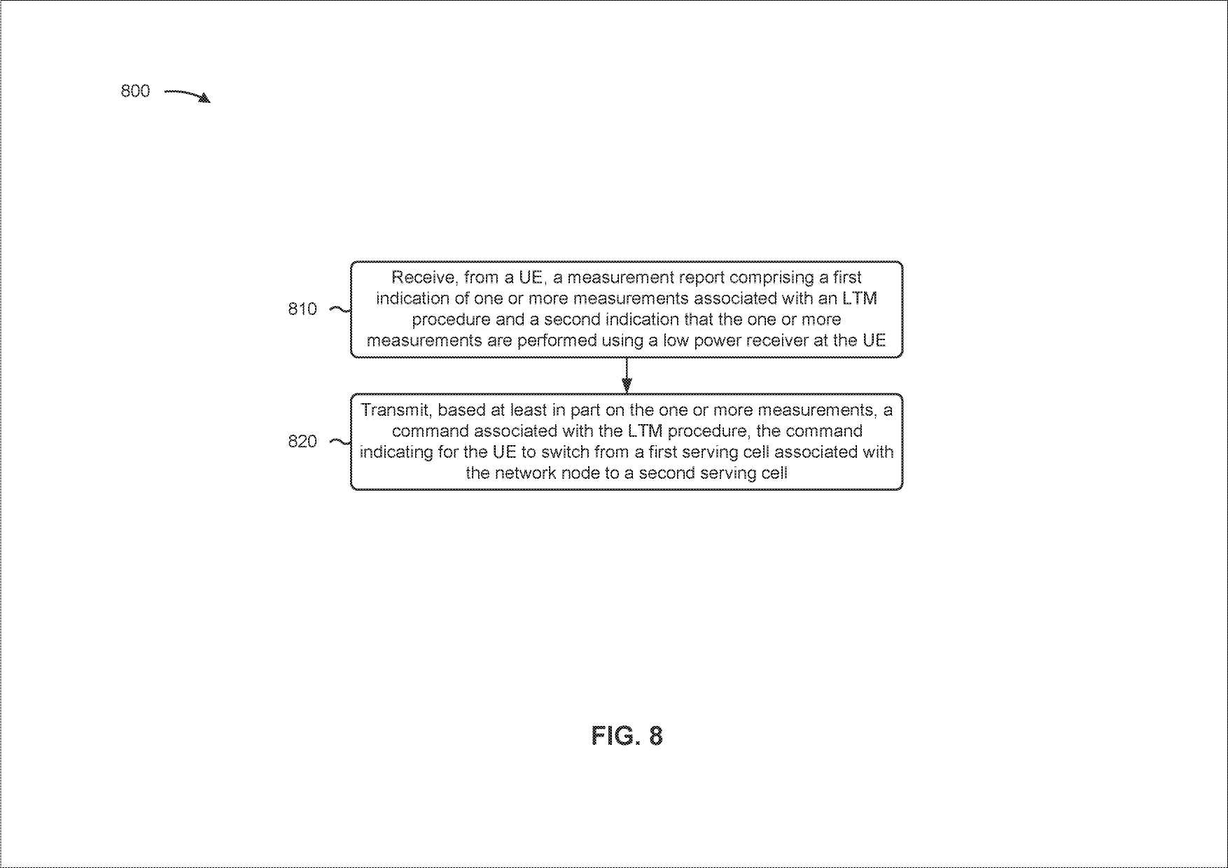

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with a mobility procedure using a low power receiver, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 8 of FIG. 8, or other processes as described herein. In some examples, executing instructions may include running the instructions, converting the instructions, compiling the instructions, and/or interpreting the instructions, among other examples.

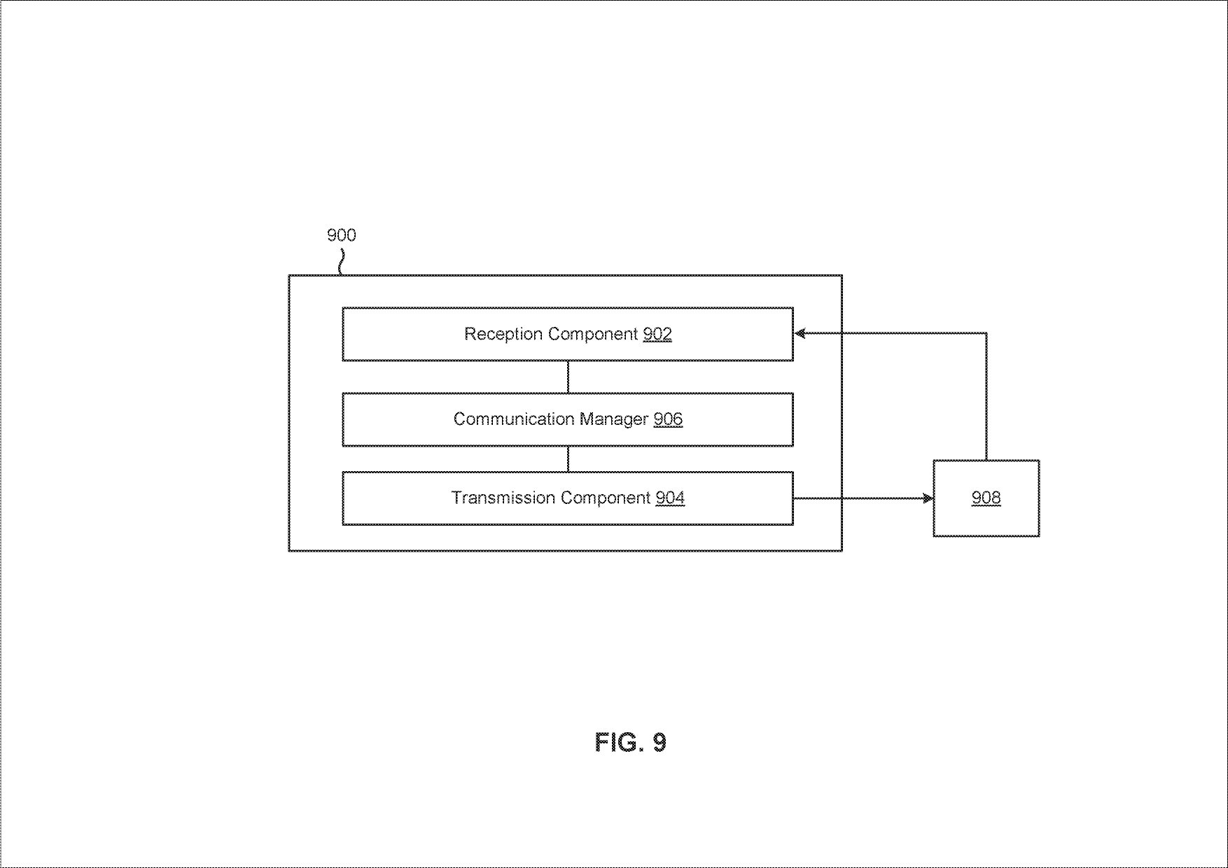

In some aspects, the UE 120 includes means for performing, using a low power receiver at the UE, one or more measurements associated with an LTM procedure (e.g., using processing system 140, communication manager 150, and/or the like); means for transmitting a measurement report comprising a first indication of the one or more measurements and a second indication that the one or more measurements are performed using the low power receiver (e.g., using processing system 140, communication manager 150, and/or the like); and/or means for receiving, based at least in part on transmitting the measurement report, a command associated with the LTM procedure, the command indicating for the UE to switch from a first serving cell to a second serving cell (e.g., using processing system 140, communication manager 150, and/or the like). The means for the UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

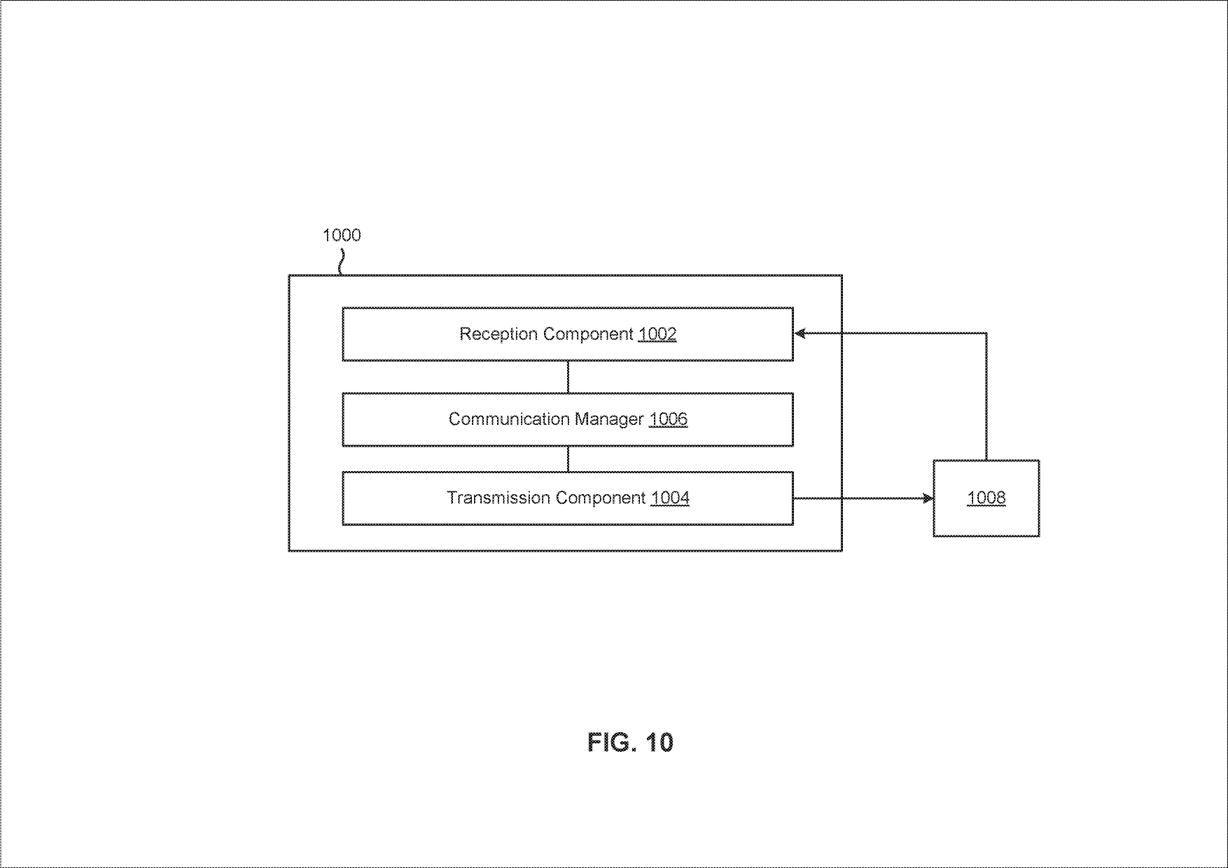

In some aspects, the network node 110 includes means for receiving, from a UE, a measurement report comprising a first indication of one or more measurements associated with an LTM procedure and a second indication that the one or more measurements are performed using a low power receiver at the UE (e.g., using processing system 145, communication manager 155, and/or the like); and/or means for transmitting, based at least in part on the one or more measurements, a command associated with the LTM procedure, the command indicating for the UE to switch from a first serving cell associated with the network node to a second serving cell (e.g., e.g., using processing system 145, communication manager 155, and/or the like). The means for the network node to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

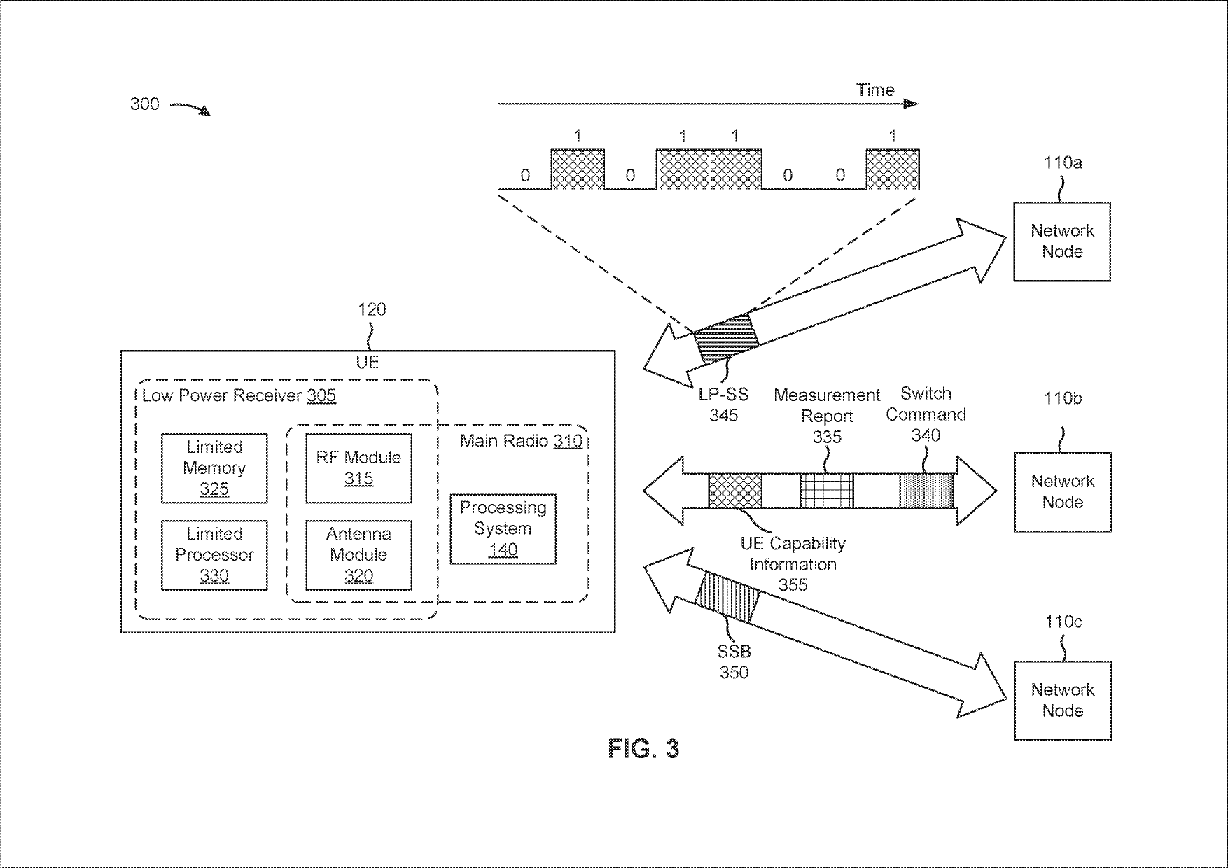

FIG. 3 is a diagram illustrating an example of a wireless communication network 300, in accordance with the present disclosure. The wireless communication network 300 includes a UE 120, the network node 110a, the network node 110b, and the network node 110b. In the wireless communication network 300, the network node 110b may provide a serving cell for the UE 120, and the network node 110a and the network node 110b may be associated with candidate serving cells.

As shown in FIG. 3, the UE 120 may be equipped with a communication system that includes the low power receiver 305 and a main radio 310. The low power receiver 305, which may also be referred to as a low power transceiver or a low power-wake up receiver, may reduce power consumption and enable low latency. For example, power saving and low latency are often conflicting goals because placing one or more components into a sleep state more often to reduce power consumption also increases latency (e.g., because data cannot be transmitted and/or received while the one or more components are in the sleep state), and because reducing the time that one or more components spend in a sleep state to reduce latency can lead to increased power consumption. Accordingly, as shown in FIG. 3, the UE 120 may be equipped with the low power receiver 305, which may be considered a companion receiver that can be used with a main radio 310 to reduce power consumption and latency.

The low power receiver 305 may include limited memory 325, a limited processor 330, an RF module 315, and an antenna module 320. The low power receiver 305 may store signals to be transmitted within the limited memory 325, which may improve a power savings of the UE 120 (e.g., as compared to the main radio 310 storing and/or transmitting signals). In some cases, the signals may be pregenerated and preprocessed, and stored in the limited memory 325 as a waveform (e.g., as in-phase and quadrature (IQ) samples). In some cases, the limited memory 325 may provide the waveform to the RF module 315 and the antenna module 320 for transmission. The limited processor 330 may be associated with limited capabilities (e.g., with fewer capabilities than a full processing system, such as the processing system 140). For example, the limited processor 330 may be capable of performing operations associated with frequency and time synchronization, measuring one or more signal metrics (e.g., RSRP) of signals that are received by the low power receiver 305.

The main radio 310 may include the processing system 140, and may also include the RF module 315 and the antenna module 320. In some cases, the main radio 310 and the low power receiver 305 sharing the RF module 315 and the antenna module 320 may reduce a cost associated with the UE 120 including both the main radio 310 and the low power receiver 305 (e.g., as compared to an example where the main radio 310 and the low power receiver 305 include separate RF modules 315 and separate antenna modules 320). Additionally, or alternatively, the antenna module 320 may include multiple antenna arrays and the UE 120 may use a first subset of the antenna arrays for the low power receiver 305 and a second subset of the antenna arrays for the main radio 310. In some cases, the low power receiver 305 may operate the RF module 315 and the antenna module 320 at a reduced capability, which may decrease an amount of power consumed by the RF module 315 and the antenna module 320 when operated for the low power receiver 305 (e.g., as compared to when the RF module 315 and antenna module 320 are operated for the main radio 310).

The UE 120 may generally use the main radio 310 to transmit and/or receive user data with the network node 110b (e.g., the serving cell of the UE 120), and the main radio 310 may be turned off or operated in a deep sleep state unless there is user data to transmit and/or receive. Furthermore, the low power receiver 305 may serve as a simple wakeup receiver for the main radio 310, and the low power receiver 305 may be active and monitoring for a low-power wake-up signal (LP-WUS) while the main radio 310 is off or in the deep sleep state. In some cases, when the main radio 310 is off or in the deep sleep state, the UE 120 may switch off one or more components associated with the processing system 140, which may reduce a power consumption of the processing system 140 when the main radio 310 is off or in the deep sleep state.

In a first state associated with the main radio 310 and the low power receiver 305 where there is no user data to be provided to the main radio 310, the main radio 310 may be off or operated in the deep sleep state unless there is user data to transmit, and the low power receiver 305 may monitor for an LP-WUS (for example, continuously, or periodically in monitoring occasions that are separated in time). Furthermore, in a second state associated with the main radio 310 and the low power receiver 305 where there is user data for the main radio 310, the low power receiver 305 may receive an LP-WUS (such as from the network node 110b) and may provide a trigger to wake or otherwise activate the main radio 310 based on detecting the LP-WUS. Accordingly, the main radio 310 may then transmit and/or receive user data.

In general, the low power receiver 305 may consume very little power (for example, a target power consumption less than 100 microwatts (µW) in the active state), which may be achieved using simple modulation schemes (for example, on-off keying (OOK)), a narrow bandwidth (for example, less than 5 MHz), and/or other suitable techniques. In this way, the low power receiver 305 can be used to reduce the time that the main radio 310 spends in an on state and/or may avoid unnecessarily waking the main radio 310 from the off or deep sleep state when there is no user data to transmit or receive, which tends to be costly from a power consumption perspective. Furthermore, because the low power receiver 305 has a very low power consumption, the low power receiver 305 can be used to frequently or continuously perform LP-WUS monitoring, which may improve latency because the main radio 310 can be woken up when there is user data that the main radio 310 needs to receive. For example, the low power receiver 305 may not suffer from the latency versus power efficiency tradeoff associated with duty cycling schemes, such as DRX. Furthermore, in addition to performing LP-WUS monitoring, which may be used for paging reception, the low power receiver 305 may monitor a low-power synchronization signal (LP-SS) for time and frequency tracking and radio resource management (RRM) measurement. In this way, by monitoring the LP-SS, serving cell and/or neighbor cell monitoring can be offloaded from the main radio 310 to the low power receiver 305 to reduce how often the main radio 310 is woken up, which can further reduce power consumption.

In some aspects, the low power receiver 305 may include an OOK WUR (also referred to as an envelope detector (ED) WUR). An OOK WUR may only detect the amplitude (such as the magnitude) of a received signal. A UE that uses an OOK WUR may detect the phase of a received signal by activating the main radio 310.

In some aspects, the low power receiver 305 may include an OFDM WUR (which may be referred to as an IQ WUR). An OFDM WUR can detect both the amplitude and phase of a received signal. For example, an OFDM WUR can obtain first information that is modulated onto a signal using OOK modulation, and second information that is modulated onto the signal using phase modulation.

In some aspects, one application of the low power receiver 305 is to monitor the LP-WUS for paging monitoring, which can be used to reduce unnecessary paging reception performed by the main radio 310. For example, the low power receiver 305 may be configured to monitor for an LP-WUS (while the main radio 310 is off or in a deep sleep state) according to a wakeup signal (WUS) monitoring periodicity. For example, the low power receiver 305 may monitor for the LP-WUS in periodic LP-WUS monitoring occasions that are spaced in time according to the WUS monitoring periodicity. Alternatively, the low power receiver 305 may be configured to continuously monitor for the LP-WUS. In general, the network node 110b may transmit an LP-WUS to the UE 120 only in cases where there is a paging message that needs to be sent to the UE 120 while the UE 120 is in an idle or inactive state (such as an RRC idle or RRC inactive state). In such cases, the low power receiver 305 may receive and detect the LP-WUS, which may trigger the low power receiver 305 to wake up the main radio 310. In some aspects, the LP-WUS may be a sequence-based WUS, which may include a predefined set of sequences (implemented, for example, using OOK modulation and/or phase modulation). As shown, the main radio 310 may wake up after a main radio wakeup time, and may then start to monitor one or more SSB transmissions to obtain synchronization with the network node 110b before monitoring and receiving the paging message in a subsequent occasion. Otherwise, in cases where the low power receiver 305 does not detect the LP-WUS, the main radio 310 may remain in the deep sleep state to save power.

In the example wireless communication network 300, the UE 120 may use the low power receiver 305 for measurements associated with an LTM procedure. For example, the network node 110b may transmit configuration information to the UE 120 indicating for the UE 120 to measure one or more downlink signals (e.g., including an LP-SS 345, an LP-WUS, and/or the SSB 350) using the low power receiver 305. In some cases, the UE 120 may transmit, and the network node 110b may receive, the UE capability information 355 indicating a capability of the UE 120 to perform measurements for the LTM procedure using the low power receiver 305 at the UE 120. For example, the UE capability information 355 may indicate a capability of the UE 120 to operate the low power receiver 305 and the main radio 310 simultaneously. Additionally, or alternatively, the UE capability information 355 may indicate one or more beamforming configurations that are supported by the low power receiver 305.

In particular, the UE 120 may use the low power receiver 305 for continuous monitoring and measuring of neighbor cells (e.g., provided by the network node 110a and/or the network node 110c). For example, the UE 120 may perform one or more measurements of a candidate serving cell (e.g., of signals transmitted by the network node 110a and/or by the network node 110c) using the low power receiver 305 while also communicating with the serving cell provided by the network node 110b using the main radio 310. For example, the UE 120 may use the low power receiver 305 to monitor for the LP-SS 345 from the network node 110a and to monitor for the SSB 350 from the network node 110c. In some cases, while the UE 120 is monitoring for the LP-SS 345 and the SSB 350 using the low power receiver 305, the UE 120 may also be communicating with the network node 110b using the main radio 310.

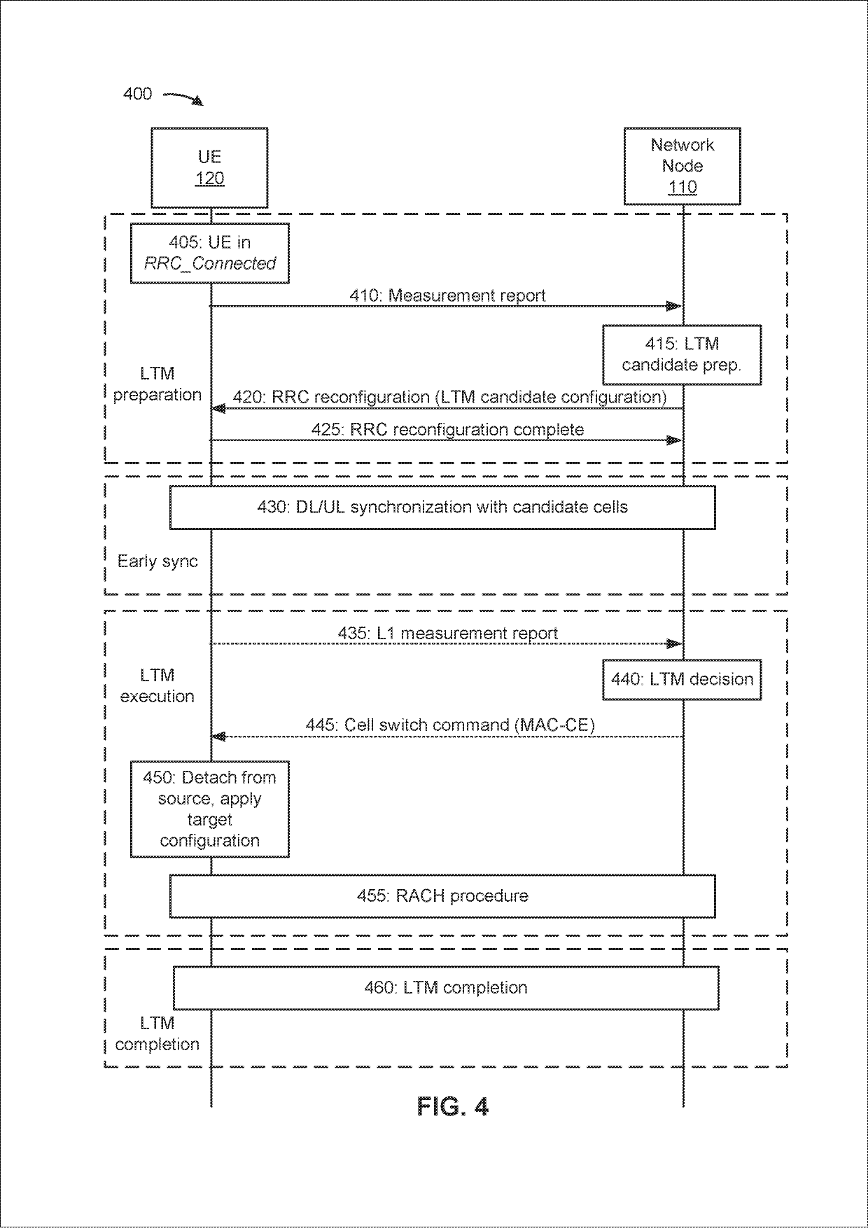

The UE 120 may perform one or more measurements of the signals received by the low power receiver 305 based on an LTM procedure. For example, the UE 120 may perform one or more measurements on the received LP-SS 345 and one or more measurements on the received SSB 350. Then, the UE 120 may transmit a measurement report 335 including an indication of the measurements associated with the LP-SS 345, an indication of the measurements associated with the SSB 350. In an example of the LTM procedure, the measurement report may be an L3 or an L1 measurement report, as further described with reference to FIG. 4. The measurement report 335 may additionally include an indication of whether each of the measurements included in the measurement report 335 were performed using the low power receiver 305 or the main radio 310. For example, the measurement report 335 may include an indication that the measurements associated with the LP-SS 345 were performed using the low power receiver 305 and an indication that the measurements associated with the SSB 350 were performed using the low power receiver 305.

Based on receiving the measurement report 335, the network node 110b may determine whether to handover the UE 120 from the network node 110b to another network node 110 (e.g., that is associated with a candidate serving cell). In some cases, the network node 110b may determine to handover the UE 120 to a candidate serving cell if a measurement associated with a reference signal (e.g., an SSB 350, an LP-SS 345) transmitted by the candidate serving cell and indicated in the measurement report 335 satisfies a threshold (e.g., exceeds a threshold). In some cases, measurements performed by a low power receiver 305 may be performed using reduced beam forming capabilities, and the network node 110 may therefore compare the measurements performed by a lower power receiver 305 to a different threshold (e.g., than measurements performed by a main radio 310). If the network node 110b determines to handover the UE 120, the network node 110b may transmit, and the UE 120 may receive, a switching command 340. The switching command 340 may be a cell switch command and may indicate for the UE 120 to switch from a first serving cell associated with the network node 110b to a second serving cell associated with another network node 110 (e.g., the network node 110a or the network node 110c).

FIG. 3 illustrates an example waveform for the LP-SS 345. In particular, FIG. 3 illustrates an example where the LP-SS 345 is an OOK signal. OOK signals may include a high power pattern and a low power pattern corresponding to a sequence of high power (e.g., high amplitude, or ‘ON’ states) durations and low power (e.g., low amplitude or ‘OFF’ states) durations. In some cases, a high duration may be used to convey an information bit (e.g., a ‘1’) and a low duration may be used to convey an information bit (e.g., a ‘0’). An OOK signal may correspond to an OOK-1 signal or an OOK-4 signal. For an OOK-1 signal, a single OFDM symbol may convey one bit of information (e.g., using an amplitude of OOK-1 waveform). Additionally, each of the subcarriers may be modulated during a high duration of the OOK-1 waveform and none of the subcarriers may be modulated (e.g., all of the subcarriers may be zero power from a base-band perspective) during a low power duration of the OOK-1 waveform. For an OOK-4 waveform, a single OFDM symbol may convey M bits of information (e.g., using an amplitude of OOK-4 waveform). Here, N subcarriers of an OOK-1 waveform (e.g., out of K total subcarriers) may be generated by a transformation (e.g., a DFT, a least square transformation), N’ samples may be generated from M bits, a signal modification may optionally be performed, and a truncation may optionally be performed.

In one case where the illustrated LP-SS 345 corresponds to an OOK-4 signal, the OOK signal may span four OFDM symbols and M may by 2 (e.g., each OFDM symbol conveys two bits of information). In another case where the illustrated OOK signal corresponds to an OOK-4 signal, the OOK signal may span two OFDM symbols and M may by 4 (e.g., each OFDM symbol conveys four bits of information). In some cases, an OFDM sequence may be overlaid onto the OOK signal (e.g., within the high power durations). The overlaid OFDM sequence may be a gold sequence, an M sequence, a computer searched sequence, a Zadoff Chu sequence, or another type of sequence).

As indicated above, FIG. 3 is provided as an example. Other examples may differ from what is described with respect to FIG. 3.

FIG. 4 is a diagram illustrating an example 400 of an LTM procedure, in accordance with the present disclosure. In some cases, the UE 120 may include aspects of the UE 120 described with reference to FIG. 3. For example, the UE 120 may include both a low power receiver and a main radio. Additionally, the UE 120 may perform one or more measurements associated with the LTM procedure using the low power receiver.

In some examples, a network node 110 may instruct a UE 120 to change serving cells, such as when the UE 120 moves away from coverage of a current serving cell (sometimes referred to as a source cell) and toward coverage of a neighboring cell (sometimes referred to as a target cell). In some cases, the network node 110 may instruct the UE 120 to change cells using a layer 3 (L3) handover procedure. An L3 handover procedure may include the network node 110 transmitting, to the UE 120, an RRC reconfiguration message indicating that the UE 120 should perform a handover procedure to a target cell, which may be transmitted in response to the UE 120 providing the network node 110 with an L3 measurement report indicating signal strength measurements associated with various cells (e.g., measurements associated with the source cell and one or more neighboring cells). In response to receiving the RRC reconfiguration message, the UE 120 may communicate with the source cell and the target cell to detach from the source cell and connect to the target cell (e.g., the UE 120 may establish an RRC connection with the target cell). Once handover is complete, the target cell may communicate with a user plane function (UPF) of a core network to instruct the UPF to switch a user plane path of the UE 120 from the source cell to the target cell. The target cell may also communicate with the source cell to indicate that handover is complete and that the source cell may be released.

L3 handover procedures may be associated with high latency and high overhead due to the multiple RRC reconfiguration messages and/or other L3 signaling and operations used to perform the handover procedures. Accordingly, in some examples, a UE 120 may be configured to perform a lower-layer (e.g., L1 and/or L2) handover procedure, sometimes referred to an LTM procedure, such as the example 400 LTM procedure shown in FIG. 4. As shown in FIG. 4, the LTM procedure may include four phases: an LTM preparation phase, an early synchronization phase (shown as “early sync” in FIG. 4), an LTM execution phase, and/or an LTM completion phase.

During the LTM preparation phase, and as shown by reference number 405, the UE 120 may be in an RRC connected state (sometimes referred to as RRC_Connected) with a source cell. In some cases, the UE 120 may enter the RRC connected state after an initial access on a serving cell associated with the network node 110. The serving cell may be associated with a first physical cell identifier (PCI).

As shown by reference number 410, the UE 120 may transmit, and the network node 110 may receive, a measurement report (sometimes referred to as a MeasurementReport), which may be an L3 measurement report. The measurement report may indicate signal strength measurements (e.g., RSRP, RSSI, RSRQ, and/or CQI) or similar measurements associated with the source cell and/or one or more neighboring cells. For example, the measurement report may include one or more L3 metrics for detected neighbor cells. In cases where the network node 110 includes a DU but does not include a CU, the network node 110 may provide the measurement report to another network node (e.g., not illustrated in FIG. 4) that includes the CU. That is, the measurement report may be communicated from the UE 120 to a gNB-CU.

The measurement report may additionally indicate whether each of the measurements is performed using a low power receiver at the UE 120 or a main radio at the UE 120. That is, one or more of the measurements indicated in the measurement report may be performed by a low power receiver at the UE 120. For example, the network node 110 may configure the UE 120 to perform measurements associated with the LTM procedure using the low power receiver at the UE 120. In such cases, the measurement report may include an indication of the one or more measurements (e.g., the LTM measurements) that are performed using the low power receiver at the UE 120. In some examples, based at least in part on the measurement report or other information, the network node 110 may decide to use LTM, and thus, as shown by reference number 415, the network node 110 may initiate LTM candidate preparation.

As shown by reference number 420, the network node 110 may transmit, and the UE 120 may receive, an RRC reconfiguration message (sometimes referred to as an RRCReconfiguration message), which may include an LTM candidate configuration. More particularly, the RRC reconfiguration message may indicate a configuration of one or more LTM candidate target cells, which may be candidate cells to become a serving cell of the UE 120 and/or cells for which the UE 120 may later be triggered to perform an LTM procedure. The LTM candidate configuration may indicate a PCI associated with the LTM candidate target cells, an SSB time location associated with SSBs transmitted by the LTM candidate target cells, a center frequency of the SSB transmitted by the LTM candidate target cells, a power associated with the SSB transmitted by the LTM candidate target cells, and/or a subcarrier spacing associated with the SSB transmitted by the LTM candidate target cells. Additionally, or alternatively, the LTM candidate configuration may indicate one or more parameters associated with an LP-SS transmitted by the LTM candidate target cells. For example, the LTM candidate configuration may indicate a binary sequence corresponding to the ‘ON-OFF’ pattern of the LP-SS (e.g., a high power pattern and low power pattern associated with the LP-SS), a type of modulation sequence associated with the LP-SS (e.g., an OOK-1, an OOK-4), and/or a quantity of symbols associated with the LP-SS. Additionally, the LTM candidate configuration may indicate the PCI corresponding to the LTM candidate target cells that transmit an LP-SS.

In some cases, the RRC reconfiguration message may indicate the LTM candidate cells, which may be indicated via a set of PCIs (e.g., PCI 0-9 in an example where the LTM candidate cells include ten candidate cells). Additionally, the RRC reconfiguration message may activate a subset of the LTM candidate cells for an L1 measurement. For example, the network node 110 may activate the subset of the LTM candidate cells for the L1 measurement that have a highest reported measured signal quality (e.g., in the L3 measurement report). In one example where the set of PCIs includes PCIs 0-9, the network node may active the subset of the LTM candidate cells corresponding to the PCI 0, PCI 3, and PCI 4. In some cases, each of the LTM candidate cells correspond to network nodes that include a DU (e.g., gNB-DUs) or network nodes that include an RU (e.g., RUs).

As shown by reference number 425, the UE 120 may store the configuration of the one or more LTM candidate cell configurations and, in response, may transmit, to the network node 110, an RRC reconfiguration complete message (sometimes referred to as an RRCReconfigurationComplete message).

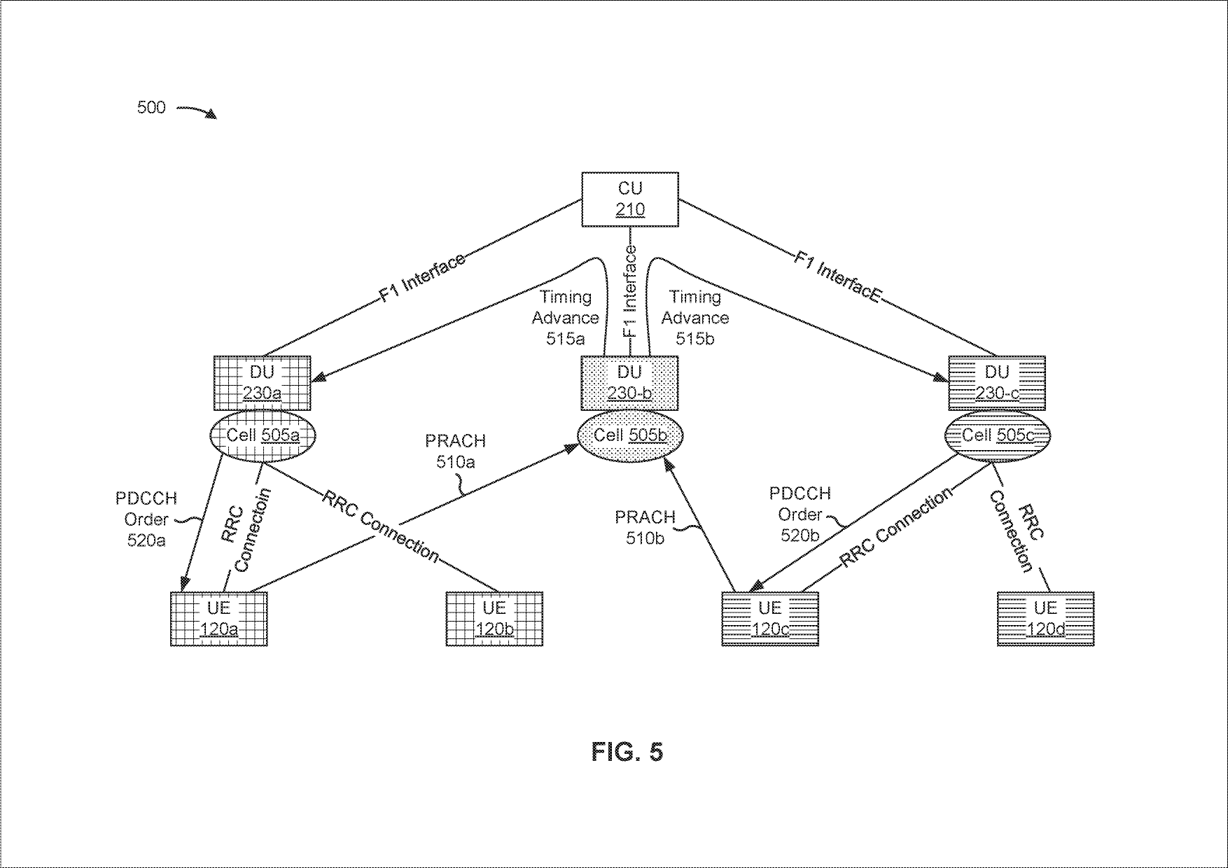

During the early synchronization phase, and as shown by reference number 430, the UE 120 may optionally perform downlink/uplink synchronization with the candidate cells associated with the one or more LTM candidate cell configurations. For example, the UE 120 may perform downlink synchronization and timing advance acquisition with the one or more candidate target cells prior to receiving an LTM switch command (which is described in more detail below in connection with reference number 445). In some aspects, performing the early synchronization with the one or more candidate cells may reduce latency associated with performing a random access channel (RACH) procedure later in the LTM procedure, which is described in more detail below in connection with reference number 455. Additionally, an example of early timing advance acquisition (e.g., during the early synchronization phase) is described with respect to FIG. 5.

During the LTM execution phase, and as shown by reference number 435, the UE 120 may perform L1 measurements on the configured LTM candidate target cells, and thus may transmit, to the network node 110, lower-layer (e.g., L1) measurement reports. In some cases, the UE 120 may perform the L1 measurements on the configured LTM candidate target cells using the low power receiver at the UE 120 (e.g., and while communicating with the network node 110 using a main radio). The UE 120 may perform the L1 measurements on the configured LTM candidate target cells using the low power receiver at the UE 120 in response to the network node 110 configuring the UE 120 to perform LTM measurements using the low power receiver. Additionally, or alternatively, the UE 120 may perform the LTM measurements using the low power receiver without the network node 110 configuring the UE 120 to use the low power receiver for LTM measurements.

In some cases, an L1 intra-frequency measurement of the configured LTM candidate target cells may be defined as having a same SSB center frequency and subcarrier spacing as the serving cell. Additionally, an L1 inter-frequency measurement may be configured, where the SSB center frequency or the subcarrier spacing of an SSB transmitted by an LTM candidate target cell is different from the serving cell.

In some cases, based at least in part on the lower-layer measurement reports, the network node 110 may identify one or more candidate serving cells (e.g., from the activated subset of LTM candidate target cells) that may be suitable serving cells for the UE 120. Then, the network node 110 may active the TCI of those suitable serving cells and acquire a timing advance associated with those suitable serving cells for a potential handover of the UE 120. As shown by reference number 440, based at least in part on the lower-layer measurement reports, the network node 110 may decide to execute an LTM cell switch to a target cell. In some cases, the target cell may be one of the identified suitable serving cells. That is, the target cell may correspond to a candidate serving cell with a best reported signal quality (e.g., in the L1 and/or L3 measurement reports).

Accordingly, as shown by reference number 445, the network node 110 may transmit, and the UE 120 may receive, a MAC-CE or similar message triggering an LTM cell switch (the MAC-CE or similar message is sometimes referred to herein as a cell switch command). The cell switch command may include an indication of a candidate configuration index associated with the target cell. Additionally, the cell switch command may include an indication of a TCI, timing advance, and bandwidth part associated with the target cell. In some cases, the cell switch command may include a unified TCI state identifier for the target serving cell. Whether the cell switch command includes the unified TCI state identifier may be based on whether a beam indication is supported, whether the TCI state for the target serving cell is determined prior to or after the network node 110 transmits the cell switch command, or both. The cell switch command may also include an indication of the active downlink or uplink bandwidth parts (e.g., via downlink bandwidth part identifiers and uplink bandwidth part identifiers). Whether the cell switch command includes the indication of the active bandwidth parts may be based on whether the target serving cell supports default bandwidth part activation. In some cases, the UE 120 may transmit an ACK in response to receiving the cell switch command from the network node 110.

As shown by reference number 450, based at least in part on receiving the cell switch command, the UE 120 may switch to the configuration of the LTM candidate target cell (e.g., the UE 120 may detach from the source cell and apply the target cell configuration). In some cases, the UE 120 may switch to the configuration of the LTM candidate target cell at a command application time (e.g., a cell switch command application time). Moreover, as shown by reference number 455, the UE 120 may perform a RACH procedure toward the target cell, such as when a timing advance associated with the target cell is not available (e.g., in examples in which the UE 120 did not perform the early synchronization as described above in connection with reference number 430).

During the LTM completion phase, and as shown by reference number 460, the UE 120 may indicate successful completion of the LTM cell switch toward the target cell. In this way, cell switch to a target cell may be performed using less overhead than for an L3 handover procedure and/or a cell switch to a target cell may be associated with reduced latency as compared to L3 handover procedure.

In some cases, after the LTM completion phase, the new serving cell may activate another subset of candidate cells for L1 measurement. Here, the UE 120 may repeat the operations described with reference to reference numbers 430, 435, 440, 445, 450, 455, and 460 with the new serving cell.

As indicated above, FIG. 4 is provided as an example. Other examples may differ from what is described with respect to FIG. 4.

FIG. 5 is a diagram illustrating an example 500 of timing advance acquisition, in accordance with the present disclosure. As shown in FIG. 5, a network node 110 and a UE 120 may communicate with one another. In some cases, a UE 120 may perform one or more operations described with reference to the example 500 as part of an LTM procedure. In the example 500, the DU 230a may be associated with the cell 505a (e.g., may be a gNB-DU that provides the cell 505a), the DU 230b may be associated with the cell 505b (e.g., may be a gNB-DU that provides the cell 505b), and DU 230c may be associated with the cell 505c (e.g., may be a gNB-DU that provides the cell 505c). Additionally, the DU 230a, DU 230b, and DU 230b may communicate with the CU 210 (e.g., via F1 interfaces).

In the example 500, the UE 120a and the UE 120b may have established RRC connections with the DU 230a. That is, the cell 505a may be the serving cell for the UE 120a and the UE 120b. Additionally, the UE 120c and the UE 120d may have established RRC connections with the DU 230c. That is, the cell 505c may be the serving cell for the UE 120c and the UE 120d. The example 500 illustrates the UE 120a performing a timing advance acquisition for the cell 505b and the UE 120c performing a timing advance acquisition for the cell 505b.

In one example of the timing advance acquisition for the UE 120a with respect to the cell 505b, the DU 230a may transmit, and the UE 120a may receive, the PDCCH order 520a. The PDCCH order 520a may include an indication of the cell 505b and a PRACH identifier. Additionally, the PDCCH order 520a may include a candidate cell identifier (e.g., of the cell 505b), an SSB for the random access occasion, and an indicator of a first transmission. That is, the PDCCH order 520a may indicate for the UE 120a to transmit a PRACH signal to the cell 505b and to include the PRACH identifier. Responsive to receiving the PDCCH order 520a, the UE 120a may transmit, and the DU 230b may receive, the PRACH 510a having the PRACH identifier. Based on receiving the PRACH 510a, the DU 230b may identify the timing advance 515a associated with the PRACH 510. Then, the DU 230b may transmit, via the CU 210, an indication of the timing advance 515a to the DU 230a.

In another example of the timing advance acquisition for the UE 120c with respect to the cell 505b, the DU 230c may transmit, and the UE 120c may receive, the PDCCH order 520b. Additionally, the PDCCH order 520b may include a candidate cell identifier (e.g., of the cell 505b), an SSB for the random access occasion, and an indicator of a first transmission. The PDCCH order 520b may include an indication of the cell 505b and a PRACH identifier. That is, the PDCCH order 520b may indicate for the UE 120c to transmit a PRACH signal to the cell 505b having the PRACH identifier. Responsive to receiving the PDCCH order 520b, the UE 120c may transmit, and the DU 230b may receive, the PRACH 510b. Based on receiving the PRACH 510b, the DU 230b may identify the timing advance 515b associated with the PRACH 510b. Then, the DU 230b may transmit, via the CU 210, an indication of the timing advance 515b to the DU 230c.

In some cases, the contention free random access (CFRA) resource for early timing advance acquisition may be shared among the UEs 120. In one example of an intra-DU timing advance acquisition, a source DU 230 (e.g., the DU 230a for the UE 120a, the DU 230c for the UE 120c) may order the UE 120 to transmit the PRACH 510 at a certain time. In another example of an inter-DU timing advance acquisition, PRACH identifier pools may be allocated on a per-DU 230 basis. Additionally, the CU 210 may identify a source DU 230 based on a received PRACH identifier. Then, the source DU 230 may identify the UE 120 associated with the PRACH identifier based on the UE 120 that was ordered to send a PRACH.

In some cases, the PDCCH orders 520 may be for timing advance acquisition without a random access response and/or MAC-CE. Here, if a retransmission of the PRACH 510 is needed, the serving cell may send another PDCCH order 520 within an indicator that the PDCCH order 520 is a retransmission. Then, the UE 120 may retransmit the PRACH 510 with a power boost (e.g., a Y*X decibel power boost, where Y corresponds to an accumulated quantity of retransmissions for the same cell 505 and X corresponds to a quantity of decibels that by which the UE 120 is preconfigured to increase the PRACH 510 transmission per retransmission). Additionally, the UE 120 may determine that the RACH procedure finishes if the UE 120 does not receive a retransmission of the PDCCH order 520 for the same cell 505 within a certain time after a last transmission of the PRACH 515 (e.g., without receiving a random access response).

As indicated above, FIG. 5 is provided as an example. Other examples may differ from what is described with respect to FIG. 5.

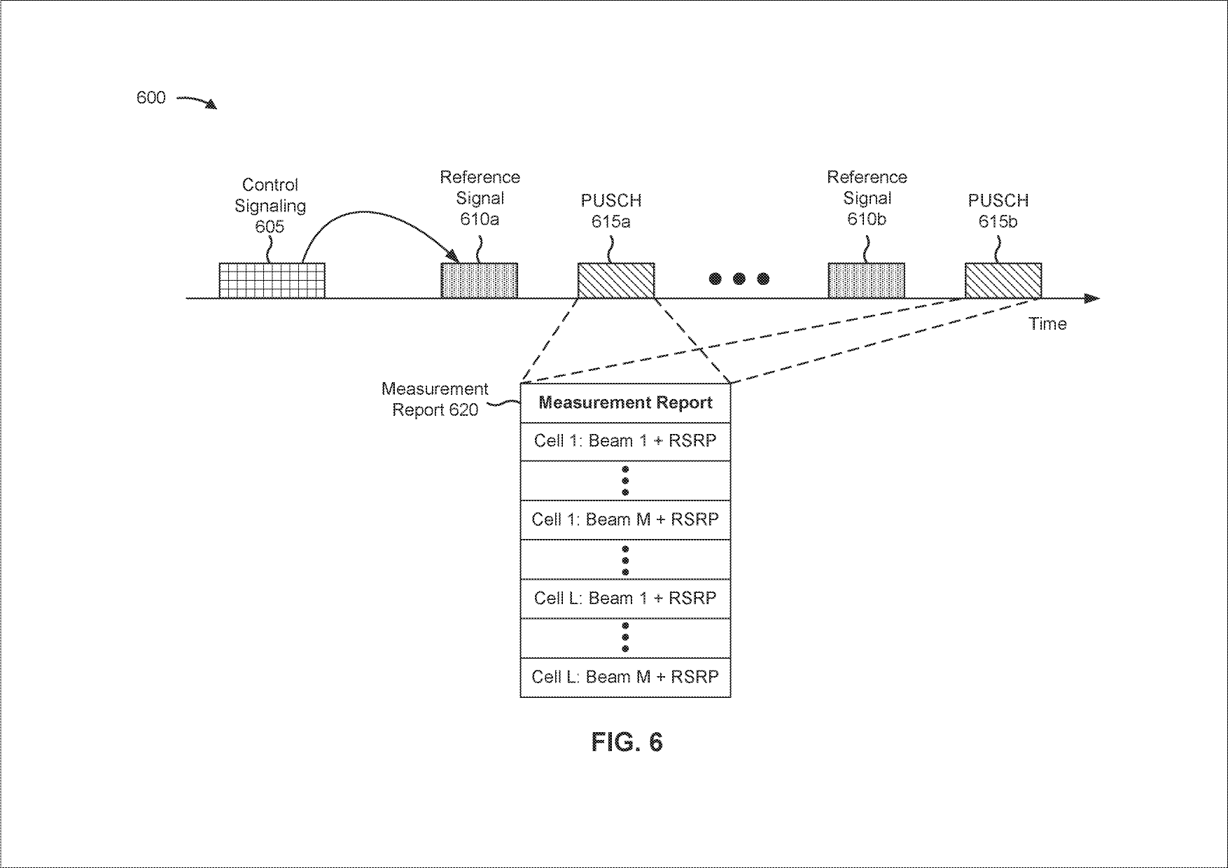

FIG. 6 is a diagram illustrating an example 600 of a measurement report transmission, in accordance with the present disclosure. In some cases, the example 600 may illustrate communications performed by a UE 120 and a network node 110 in order for the UE 120 to provide a measurement report 620 to the network node 110 (e.g., as part of an LTM procedure as described herein).

A network node 110 may transmit, and the UE 120 may receive, control signaling 605 indicating a configuration for a measurement report 620. In some cases, the control signaling 605 may include DCI signaling, a MAC-CE, or some other type of control signaling. In some cases, the control signaling 605 may activate a semipersistent measurement report transmission.

The control signaling 605 may configure a quantity of beams that the UE 120 is to report for each candidate serving cell (e.g., M), and a quantity of candidate cells the UE 120 is to include in the measurement report 620 (e.g., L). Accordingly, the UE 120 may transmit a measurement report 620 that includes reported measurements for M*L beams. In some cases, the UE 120 may be have a capability to support up to a maximum quantity of the M and L. Here, the UE 120 may indicate (e.g., within UE capability information, such as the UE capability information 355 described with reference to FIG. 3) the maximum quantity of beams that the UE 120 may report on (e.g., M*L). Additionally, the UE 120 may be capable of reporting at least four total measurements (e.g., M*L may be greater than or equal to four).

The reference signal 610a and the reference signal 610b may correspond to signal(s) transmitted by one or more candidate serving cells. For example, the reference signals 610 may include an SSB, an LP-SS, or some other type of reference signal. The UE 120 may perform one or more measurements on the reference signals 610 to detect a signal quality associated with the corresponding reference signal 610. As described herein, the UE 120 may perform the one or more measurements using a low power receiver at the UE 120 while maintaining communications with a serving cell of the UE using a main radio at the UE. Then, the UE 120 may transmit, in accordance with the configuration indicated by the control signaling 605, the measurement report 620 via a PUSCH 615. For example, the UE 120 may transmit a first measurement report 620 via the PUSCH 615a and a second measurement report 620 via the PUSCH 615b. The UE 120 may transmit the measurement report 620 periodically or semi-periodically on the PUSCH 615. Additionally or alternatively, the UE 120 may transmit the measurement report 620 semi-periodically or aperiodically on the PUSCH 615. In the example 600, the measurement report 620 includes an indication of beam and an RSRP associated with that beam. The beam may correspond to a receive beam used by the UE 120 to perform the corresponding measurement. While the example 600 illustrates the measurement report 620 including an RSRP associated with each beam, the measurement report 620 may include some other measurement. For example, the measurement report 620 may include an RSSI and/or an RSRQ associated with each beam.

As indicated above, FIG. 6 is provided as an example. Other examples may differ from what is described with respect to FIG. 6.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with mobility procedures using a low power receiver.

As shown in FIG. 7, in some aspects, process 700 may include performing, using a low power receiver at the UE, one or more measurements associated with an LTM procedure (block 710). For example, the UE (e.g., using communication manager 150, the reception component 902 depicted in FIG. 9, and/or the communication manager 906 depicted in FIG. 9) may perform, using a low power receiver at the UE, one or more measurements associated with an LTM procedure, as described above, for example, with reference to FIGS. 3-6.

As further shown in FIG. 7, in some aspects, process 700 may include transmitting a measurement report comprising a first indication of the one or more measurements and a second indication that the one or more measurements are performed using the low power receiver (block 720). For example, the UE (e.g., using communication manager 150 and/or transmission component 904, depicted in FIG. 9) may transmit a measurement report comprising a first indication of the one or more measurements and a second indication that the one or more measurements are performed using the low power receiver, as described above, for example, with reference to FIGS. 3-6.

As further shown in FIG. 7, in some aspects, process 700 may include receiving, based at least in part on transmitting the measurement report, a command associated with the LTM procedure, the command indicating for the UE to switch from a first serving cell to a second serving cell (block 730). For example, the UE (e.g., using communication manager 150 and/or reception component 902, depicted in FIG. 9) may receive, based at least in part on transmitting the measurement report, a command associated with the LTM procedure, the command indicating for the UE to switch from a first serving cell to a second serving cell, as described above, for example, with reference to FIGS. 3-6.

Process 700 may include additional aspects, such as any single aspect or any combination of aspects described below and/or in connection with one or more other processes described elsewhere herein.

In a first aspect, process 700 includes transmitting signaling indicating UE capability information associated with the low power receiver at the UE, wherein performing the one or more measurements is based at least in part on the UE capability information.

In a second aspect, the UE capability information indicates a capability of the UE to operate a main radio at the UE and the low power receiver simultaneously.

In a third aspect, the UE capability information indicates that the UE is capable of performing measurements for LTM procedures using the low power receiver.

In a fourth aspect, the UE capability information indicates one or more beamforming configurations that are supported by the low power receiver.

In a fifth aspect, process 700 includes maintaining a connection with the first serving cell using a main radio at the UE while performing the one or more measurements using the low power receiver.

In a sixth aspect, the one or more measurements comprise a first measurement of an LP-SS received from one of a plurality of candidate serving cells, a second measurement of a low power wake up signal received from one of the plurality of candidate serving cells, a third measurement of an SSB received from one of the plurality of candidate serving cells, a fourth measurement of a reference signal received from one of the plurality of candidate serving cells, or a combination thereof.

In a seventh aspect, process 700 includes receiving a configuration message for the LTM procedure, wherein performing the one or more measurements is based at least in part on the configuration message.

In an eighth aspect, the configuration message indicates a set of resources corresponding to LP-SSs transmitted by one or more candidate serving cells, wherein performing the one or more measurements comprises monitoring of the set of resources to detect a signal quality of the LP-SSs.

In a ninth aspect, the configuration message further indicates a high power pattern and low power pattern associated with the LP-SSs, a type of modulation sequence associated with the LP-SSs, a quantity of symbols associated with the LP-SSs, or a combination thereof.

In a tenth aspect, the configuration message further indicates physical cell identities of the one or more candidate serving cells that transmit the LP-SSs.

In an eleventh aspect, the configuration message indicates one or more signal types configured for low power receiver measurements.

In a twelfth aspect, the measurement report is an L1 measurement report or an L3 measurement report for the LTM procedure.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node, in accordance with the present disclosure. Example process 800 is an example where the apparatus or the network node (e.g., network node 110) performs operations associated with mobility procedures using a low power receiver.

As shown in FIG. 8, in some aspects, process 800 may include receiving, from a UE, a measurement report comprising a first indication of one or more measurements associated with an LTM procedure and a second indication that the one or more measurements are performed using a low power receiver at the UE (block 810). For example, the network node (e.g., using communication manager 150 and/or reception component 1002, depicted in FIG. 10) may receive, from a UE, a measurement report comprising a first indication of one or more measurements associated with an LTM procedure and a second indication that the one or more measurements are performed using a low power receiver at the UE, as described above, for example, with reference to FIGS. 3-6.

As further shown in FIG. 8, in some aspects, process 800 may include transmitting, based at least in part on the one or more measurements, a command associated with the LTM procedure, the command indicating for the UE to switch from a first serving cell associated with the network node to a second serving cell (block 820). For example, the network node (e.g., using communication manager 150 and/or transmission component 1004, depicted in FIG. 10) may transmit, based at least in part on the one or more measurements, a command associated with the LTM procedure, the command indicating for the UE to switch from a first serving cell associated with the network node to a second serving cell, as described above, for example, with reference to FIGS. 3-6.

Process 800 may include additional aspects, such as any single aspect or any combination of aspects described below and/or in connection with one or more other processes described elsewhere herein.

In a first aspect, process 800 includes receiving signaling indicating UE capability information associated with the low power receiver at the UE, wherein receiving the measurement report is based at least in part on the UE capability information.

In a second aspect, the UE capability information indicates a capability of the UE to operate a main radio at the UE and the low power receiver simultaneously.

In a third aspect, the UE capability information indicates that the UE is capable of performing measurements for LTM procedures using the low power receiver.

In a fourth aspect, the UE capability information indicates one or more beamforming configurations that are supported by the low power receiver.

In a fifth aspect, the one or more measurements comprise a first measurement of an LP-SS received from one of a plurality of candidate serving cells, a second measurement of a low power wake up signal received from one of the plurality of candidate serving cells, a third measurement of an SSB received from one of the plurality of candidate serving cells, a fourth measurement of a reference signal received from one of the plurality of candidate serving cells, or a combination thereof.

In a sixth aspect, process 800 includes transmitting a configuration message for the LTM procedure, wherein receiving the measurement report is based at least in part on the configuration message.

In a seventh aspect, the configuration message indicates a set of resources corresponding to LP-SSs transmitted by one or more candidate serving cells.

In an eighth aspect, the configuration message further indicates a high power pattern and low power pattern associated with the LP-SSs, a type of modulation sequence associated with the LP-SSs, a quantity of symbols associated with the LP-SSs, or a combination thereof.

In a ninth aspect, the configuration message further indicates physical cell identities of the one or more candidate serving cells that transmit the LP-SSs.

In a tenth aspect, the configuration message indicates one or more signal types configured for low power receiver measurements.

In an eleventh aspect, the measurement report is an L1 measurement report or an L3 measurement report for the LTM procedure.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 3-6. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The communication manager 906 may perform, using a low power receiver at the UE, one or more measurements associated with an LTM procedure. The transmission component 904 may transmit a measurement report comprising a first indication of the one or more measurements and a second indication that the one or more measurements are performed using the low power receiver. The reception component 902 may receive, based at least in part on transmitting the measurement report, a command associated with the LTM procedure, the command indicating for the UE to switch from a first serving cell to a second serving cell.

The transmission component 904 may transmit signaling indicating UE capability information associated with the low power receiver at the UE, wherein performing the one or more measurements is based at least in part on the UE capability information.

The communication manager 906 may maintain a connection with the first serving cell using a main radio at the UE while performing the one or more measurements using the low power receiver.

The reception component 902 may receive a configuration message for the LTM procedure, wherein performing the one or more measurements is based at least in part on the configuration message.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 3-6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive, from a UE, a measurement report comprising a first indication of one or more measurements associated with an LTM procedure and a second indication that the one or more measurements are performed using a low power receiver at the UE. The transmission component 1004 may transmit, based at least in part on the one or more measurements, a command associated with the LTM procedure, the command indicating for the UE to switch from a first serving cell associated with the network node to a second serving cell.

The reception component 1002 may receive signaling indicating UE capability information associated with the low power receiver at the UE, wherein receiving the measurement report is based at least in part on the UE capability information.

The transmission component 1004 may transmit a configuration message for the LTM procedure, wherein receiving the measurement report is based at least in part on the configuration message.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a UE, comprising: performing, using a low power receiver at the UE, one or more measurements associated with an LTM procedure; transmitting a measurement report comprising a first indication of the one or more measurements and a second indication that the one or more measurements are performed using the low power receiver; and receiving, based at least in part on transmitting the measurement report, a command associated with the LTM procedure, the command indicating for the UE to switch from a first serving cell to a second serving cell.

Aspect 2: The method of Aspect 1, further comprising: transmitting signaling indicating UE capability information associated with the low power receiver at the UE, wherein performing the one or more measurements is based at least in part on the UE capability information.

Aspect 3: The method of Aspect 2, wherein the UE capability information indicates a capability of the UE to operate a main radio at the UE and the low power receiver simultaneously.

Aspect 4: The method of Aspect 2, wherein the UE capability information indicates that the UE is capable of performing measurements for LTM procedures using the low power receiver.

Aspect 5: The method of Aspect 2, wherein the UE capability information indicates one or more beamforming configurations that are supported by the low power receiver.

Aspect 6: The method of any of Aspects 1-5, further comprising: maintaining a connection with the first serving cell using a main radio at the UE while performing the one or more measurements using the low power receiver.

Aspect 7: The method of any of Aspects 1-6, wherein the one or more measurements comprise a first measurement of an LP-SS received from one of a plurality of candidate serving cells, a second measurement of a low power wake up signal received from one of the plurality of candidate serving cells, a third measurement of an SSB received from one of the plurality of candidate serving cells, a fourth measurement of a reference signal received from one of the plurality of candidate serving cells, or a combination thereof.

Aspect 8: The method of any of Aspects 1-7, further comprising: receiving a configuration message for the LTM procedure, wherein performing the one or more measurements is based at least in part on the configuration message.

Aspect 9: The method of Aspect 8, wherein the configuration message indicates a set of resources corresponding to LP-SSs transmitted by one or more candidate serving cells, wherein performing the one or more measurements comprises monitoring of the set of resources to detect a signal quality of the LP-SSs.

Aspect 10: The method of Aspect 9, wherein the configuration message further indicates a high power pattern and low power pattern associated with the LP-SSs, a type of modulation sequence associated with the LP-SSs, a quantity of symbols associated with the LP-SSs, or a combination thereof.

Aspect 11: The method of Aspect 9, wherein the configuration message further indicates physical cell identities of the one or more candidate serving cells that transmit the LP-SSs.

Aspect 12: The method of Aspect 8, wherein the configuration message indicates one or more signal types configured for low power receiver measurements.

Aspect 13: The method of any of Aspects 1-12, wherein the measurement report is an L1 measurement report or an L3 measurement report for the LTM procedure.

Aspect 14: A method of wireless communication performed by a network node, comprising: receiving, from a UE, a measurement report comprising a first indication of one or more measurements associated with an LTM procedure and a second indication that the one or more measurements are performed using a low power receiver at the UE; and transmitting, based at least in part on the one or more measurements, a command associated with the LTM procedure, the command indicating for the UE to switch from a first serving cell associated with the network node to a second serving cell.

Aspect 15: The method of Aspect 14, further comprising: receiving signaling indicating UE capability information associated with the low power receiver at the UE, wherein receiving the measurement report is based at least in part on the UE capability information.

Aspect 16: The method of Aspect 15, wherein the UE capability information indicates a capability of the UE to operate a main radio at the UE and the low power receiver simultaneously.

Aspect 17: The method of Aspect 15, wherein the UE capability information indicates that the UE is capable of performing measurements for LTM procedures using the low power receiver.

Aspect 18: The method of Aspect 15, wherein the UE capability information indicates one or more beamforming configurations that are supported by the low power receiver.

Aspect 19: The method of any of Aspects 14-18, wherein the one or more measurements comprise a first measurement of an LP-SS received from one of a plurality of candidate serving cells, a second measurement of a low power wake up signal received from one of the plurality of candidate serving cells, a third measurement of an SSB received from one of the plurality of candidate serving cells, a fourth measurement of a reference signal received from one of the plurality of candidate serving cells, or a combination thereof.

Aspect 20: The method of any of Aspects 14-19, further comprising: transmitting a configuration message for the LTM procedure, wherein receiving the measurement report is based at least in part on the configuration message.

Aspect 21: The method of Aspect 20, wherein the configuration message indicates a set of resources corresponding to LP-SSs transmitted by one or more candidate serving cells.

Aspect 22: The method of Aspect 21, wherein the configuration message further indicates a high power pattern and low power pattern associated with the LP-SSs, a type of modulation sequence associated with the LP-SSs, a quantity of symbols associated with the LP-SSs, or a combination thereof.

Aspect 23: The method of Aspect 21, wherein the configuration message further indicates physical cell identities of the one or more candidate serving cells that transmit the LP-SSs.

Aspect 24: The method of Aspect 20, wherein the configuration message indicates one or more signal types configured for low power receiver measurements.

Aspect 25: The method of any of Aspects 14-24, wherein the measurement report is an L1 measurement report or an L3 measurement report for the LTM procedure.

Aspect 26: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-25.

Aspect 27: An apparatus for wireless communication at a device, the apparatus comprising one or more memories and one or more processors coupled to the one or more memories, the one or more processors configured to cause the device to perform the method of one or more of Aspects 1-25.

Aspect 28: An apparatus for wireless communication, the apparatus comprising at least one means for performing the method of one or more of Aspects 1-25.

Aspect 29: A non-transitory computer-readable medium storing code for wireless communication, the code comprising instructions executable by one or more processors to perform the method of one or more of Aspects 1-25.

Aspect 30: A non-transitory computer-readable medium storing a set of instructions for wireless communication, the set of instructions comprising one or more instructions that, when executed by one or more processors of a device, cause the device to perform the method of one or more of Aspects 1-25.

Aspect 31: A device for wireless communication, the device comprising a processing system that includes one or more processors and one or more memories coupled with the one or more processors, the processing system configured to cause the device to perform the method of one or more of Aspects 1-25.

Aspect 32: An apparatus for wireless communication at a device, the apparatus comprising one or more memories and one or more processors coupled to the one or more memories, the one or more processors individually or collectively configured to cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
perform, using a low power receiver at the UE, one or more measurements associated with a lower layer triggered mobility procedure;
transmit a measurement report comprising a first indication of the one or more measurements and a second indication that the one or more measurements are performed using the low power receiver; and
receive, based at least in part on transmitting the measurement report, a command associated with the lower layer triggered mobility procedure, the command indicating for the UE to switch from a first serving cell to a second serving cell.

2. The apparatus of claim 1, wherein the one or more processors are further configured to cause the UE to:
transmit signaling indicating UE capability information associated with the low power receiver at the UE, wherein performing the one or more measurements is based at least in part on the UE capability information.

3. The apparatus of claim 2, wherein the UE capability information indicates a capability of the UE to operate a main radio at the UE and the low power receiver simultaneously.

4. The apparatus of claim 2, wherein the UE capability information indicates that the UE is capable of performing measurements for lower layer triggered mobility procedures using the low power receiver.

5. The apparatus of claim 2, wherein the UE capability information indicates one or more beamforming configurations that are supported by the low power receiver.

6. The apparatus of claim 1, wherein the one or more processors are further configured to cause the UE to:
maintain a connection with the first serving cell using a main radio at the UE while performing the one or more measurements using the low power receiver.

7. The apparatus of claim 1, wherein the one or more measurements comprise a first measurement of a low power-synchronization signal received from one of a plurality of candidate serving cells, a second measurement of a low power wake up signal received from one of the plurality of candidate serving cells, a third measurement of a synchronization signal block received from one of the plurality of candidate serving cells, a fourth measurement of a reference signal received from one of the plurality of candidate serving cells, or a combination thereof.

8. The apparatus of claim 1, wherein the one or more processors are further configured to cause the UE to:
receive a configuration message for the lower layer triggered mobility procedure, wherein performing the one or more measurements is based at least in part on the configuration message.

9. The apparatus of claim 8, wherein the configuration message indicates a set of resources corresponding to low power-synchronization signals transmitted by one or more candidate serving cells, wherein performing the one or more measurements comprises monitoring of the set of resources to detect a signal quality of the low power-synchronization signals.

10. The apparatus of claim 9, wherein the configuration message further indicates a high power pattern and low power pattern associated with the low power-synchronization signals, a type of modulation sequence associated with the low power-synchronization signals, a quantity of symbols associated with the low power-synchronization signals, or a combination thereof.

11. The apparatus of claim 9, wherein the configuration message further indicates physical cell identities of the one or more candidate serving cells that transmit the low power-synchronization signals.

12. The apparatus of claim 8, wherein the configuration message indicates one or more signal types configured for low power receiver measurements.

13. The apparatus of claim 1, wherein the measurement report is a layer 1 (L1) measurement report or a layer 3 (L3) measurement report for the lower layer triggered mobility procedure.

14. A method of wireless communication performed by a user equipment (UE), comprising:
performing, using a low power receiver at the UE, one or more measurements associated with a lower layer triggered mobility procedure;
transmitting a measurement report comprising a first indication of the one or more measurements and a second indication that the one or more measurements are performed using the low power receiver; and
receiving, based at least in part on transmitting the measurement report, a command associated with the lower layer triggered mobility procedure, the command indicating for the UE to switch from a first serving cell to a second serving cell.

15. The method of claim 14, further comprising:
transmitting signaling indicating UE capability information associated with the low power receiver at the UE, wherein performing the one or more measurements is based at least in part on the UE capability information.

16. The method of claim 15, wherein the UE capability information indicates a capability of the UE to operate a main radio at the UE and the low power receiver simultaneously.

17. The method of claim 15, wherein the UE capability information indicates that the UE is capable of performing measurements for lower layer triggered mobility procedures using the low power receiver.

18. The method of claim 15, wherein the UE capability information indicates one or more beamforming configurations that are supported by the low power receiver.

19. The method of claim 14, further comprising:
maintaining a connection with the first serving cell using a main radio at the UE while performing the one or more measurements using the low power receiver.

20. A non-transitory computer-readable medium storing a set of instructions for wireless communication, the set of instructions comprising:
one or more instructions that, when executed by one or more processors of a user equipment (UE), cause the UE to:
perform, using a low power receiver at the UE, one or more measurements associated with a lower layer triggered mobility procedure;
transmit a measurement report comprising a first indication of the one or more measurements and a second indication that the one or more measurements are performed using the low power receiver; and
receive, based at least in part on transmitting the measurement report, a command associated with the lower layer triggered mobility procedure, the command indicating for the UE to switch from a first serving cell to a second serving cell.
